(19) United States
(12) Patent Application Publication
(10) Pub. No.: US 2024/0392063 A1
(43) Pub. Date: Nov. 28, 2024

(54) Polyhydroxyalkanoate Copolymers Prepared by Ring-Opening Polymerization and Related Compositions and Articles

(71) Applicant: EXXONMOBIL CHEMICAL PATENTS INC., Baytown, TX (US)

(72) Inventors: Agostino Pietrangelo, Whitehouse Station, NJ (US); Carlos R. Lopez-Barron, Houston, TX (US); Timothy D. Shaffer, Plainfield, NJ (US); Pamela J. Wright, Easton, PA (US)

(21) Appl. No.: 18/694,729

(22) PCT Filed: Sep. 26, 2022
(86) PCT No.: PCT/US2022/077020

§ 371 Date: Mar. 22, 2024

Related U.S. Application Data
(60) Provisional application No. 63/250,583, filed on Sep. 30, 2021.

(51) Int. Cl. C08G 63/08; C08G 63/81; C08G 63/82

(52) U.S. Cl. CPC C08G 63/08; C08G 63/81; C08G 63/823

(57) ABSTRACT

Embodiments described herein relate to polyhdroxyalkanoate (PHA) copolymers and methods for their preparation utilizing ring-opening polymerization of lactones. Variations of the monomer composition, % of alternation, tacticity, and/or microstructure allow for tailoring of mechanical properties that fall into the elastomer, plastomer, and thermoplastic range.

### CROSS REFERENCE TO RELATED APPLICATIONS

This application claims the benefit of and priority to US Provisional Application No. 63/250,583 filed Sep. 30, 2021, the disclosure of which is incorporated herein by reference.

### TECHNOLOGICAL FIELD

Exemplary embodiments described herein relate to a method for preparing polyhydroxyalkanoates (PHAs) and copolymers made from such method.

### BACKGROUND

Polyhydroxyalkanoates (PHAs) are aliphatic polyesters that possess mechanical properties that are comparable to polyolefins including linear low density polyethylene (LLDPE), propylene-based elastomers, and isotactic polypropylene (iPP). The most common PHA is poly(3-hydroxybutyrate) (P3HB), an isotactic thermoplastic that is produced by bacterial fermentation of various carbon sources (methane, cane sugar, beet sugar, corn, vegetable oil). This highly crystalline brittle polymer has a melt transition temperature (Tₘ) which approaches its decomposition temperature, features that limit its processing capability and commercial value. Since biogenic PHAs are limited to an isotactic microstructure, copolymers comprising 3-hydroxybutyrate and longer chain congeners (e.g., 3hydroxyhexanoate, 3-hydroxyheptanoate, or 3-hydroxyoctanoate) must be prepared as a means to reduce Tₘ and improve mechanical properties. The ring-opening polymerization (ROP) of β-butyrolactone (BBL) offers an alternative route to a P3HB-like polymer, poly(β-butyrolactone) (PBBL) that exploits the ring strain of the lactone to promote polymerization. Unlike the biogenic route, this pathway provides flexibility to make PBBL with syndiotactic, isotactic, or atactic microstructures, based on the appropriate combination of catalyst and polymerization conditions. For instance, tin-based catalysts produce atactic and syndiorich PHA polymers. (See, for example, Yori, H. et al. (1999) “Ring-Opening Copolymerization of (R)-β-Butyrolactone with Macrolide: A New Series of Poly(Hydroxyalkanoate)s,” Macromolecules, v.32(10), pp. 3537-3539, Yori, H. et al. (1993) “Ring-Opening Polymerization of Optically Active β-Butyrolactone using Distannoxane Catalysts: Synthesis of High Molecular Weight Poly(3-hydroxybutyrate),” Macromolecules, v.26(20), pp. 5533-5534, Kricheldorf, H. et al. (1997) “Polylactones. 41. Polymerizations of β-_{D,L}-Butyrolactone with Dialkyltinoxides as Initiators,” Macromolecules, v.30(19), pp. 5693-5697, and Moller, M. et al. (2000) “Sn(OTf)₂ and Sc(OTf)₃: Efficient and Versatile Catalysts for the Controlled Polymerization of Lactones,” J. Polym. Sci.: Part A: Polym. Chem., v.38(11), pp. 2067-2074, each of which is incorporated by reference herein in its entirety), while chromium-based catalysts produce moderately isotactic PBBL (see, for example, Zintl, M. et al. (2008) “Variable Isotactic Poly(hydroxybutyrate) from Racemic β-Butyrolactone: Microstructure Control by Achiral Chromium(III) Salophen Complexes,” Angew. Chem. Int. Ed., v.47(18), pp. 3458-3460, the entirety of which is hereby incorporated by reference). The ability to vary the tacticity of the homopolymer is a valuable one, as it enables thermal and mechanical property tailoring without the use of a copolymer.

More recently, aluminum, zinc, indium, Group 3 and lanthanide-based catalysts have been developed to produce atactic and syndiotactic PHA polymers. (see, for example, Rieth, L. et al. (2002) “Single-Site Beta-Diiminate Zinc Catalysts for the Ring-Opening Polymerization of Beta-Butyrolactone and Beta-Valerolactone to Poly(3-hydroxyalkanoates),” J. Am. Chem, Soc., v.124(51), pp. 15239-15248, Ebrahimi. T. et al. (2016) “Highly Active Chiral Zinc Catalysts for immortal Polymerization of, β-Butyrolactone Form Melt Processable Syndio-Rich Poly(hydroxybutyrate),” Macromolecules, v.49(23), pp. 8812-8824, Lyubov, D. et al. (2019) “Rare-Earth Metal Complexes as Catalysts for Ring-Opening Polymerization of Cyclic Esters,” Coord. Chem. Rev., v.392, pp. 83-145, Shaik, M. et al. (2019) “Cyclic and Linear Polyhydroxylbutyrates from Ring-Opening Polymerization of β-Butyrolactone with Amido-Oxazolinate Zinc Catalysts,” Macromolecules, v.52(1), pp. 157-166, Sinenkov, M. et al. (2011) “Neodymium Borohydride Complexes Supported by diamino-bis(phenoxide) ligands: Diversity of Synthetic and Structural Chemistry, and Catalytic Activity in Ring-Opening Polymerization of Cyclic Esters,” New J. Chem., v.35(1), pp. 204-212, Jaffredo, C. et al. (2013) “Poly(hydroxyalkanoate) Block or Random Copolymers of β-Butyrolactone and Benzyl β-Malolactone: A Matter of Catalytic Tuning,” Macromolecules, v.46(17), pp. 6765-6776, Ajella, N. et al. (2009) “Syndiotactic-Enriched Poly(3-hydroxybutyrate)s via Stereoselective Ring-Opening Polymerization of Racemic β-Butyrolactone with Discrete Yttrium Catalysts,” Macromolecules, v.42(4), pp. 987-993, Altenbuchner, P. et al. (2015) “Mechanistic Investigations of the Stereoselective Rare Earth Metal-Mediated Ring-Opening Polymerization of β-Butyrolactone,” Chem. Eur. J., v.21(39), pp. 13609-13617, Garcia-Valle, F. et al. (2018) “Biodegradable PHB from rac-β-Butyrolactone: Highly Controlled ROP Mediated by a Pentacoordinated Aluminum Complex,” Organometallics, v.37(6), pp. 837-840, and Ebrahimi, T. et al. (2015) “Synthesis and Rheological Characterization of Star-Shaped and Linear Poly(hydroxybutyrate),” Macromolecules, v.48(18), pp. 6672-6681, each of which is incorporated herein by reference in its entirety). Conventional results indicate that ligands of the type ONO, ONNO or ONYO (Y=amine, ether, thioether, heteroatom containing cyclic functional group etc.) may be suitable for ROP of lactones including BBL. However, the examples reported in literature are limited to only a few R groups such as halogen atoms, —CPh₃, —CMePh₂, —CMe₂tBu and CMe₂CF₃Ph. For the ONO type ligands the selection of R is even more limited, essentially limited to silyl groups such as SiPh₃ and SiMe₂tBu (see, for example, Grunova, E. et al. (2010) “Group 3 Metal Complexes Supported by Tridentate Pyridine—and Thiophene-Linked bis(naphtholate) Ligands: Synthesis, Structure, and use in Stereoselective Ring-Opening Polymerization of Racemic Lactide and β-Butyrolactone,” Dalton Trans., v.39, pp. 6739-6752, the entirety of which is hereby incorporated by reference in its entirety.)

Additional background can be found in the following 15 documents, each of which is incorporated by reference in its entirety.
1. Kramer, J. et al. (2009) “Polymerization of Enantiopure Monomers Using Syndiospecific Catalysts: A New Approach To Sequence Control in Polymer Synthesis,” J. Am. Chem. Soc., v.131(44), pp. 16042-16044.
2. Ajellal, N. et al. (2009) “Syndiotactic-Enriched Poly(3-hydroxybutyrate) s via Stereoselective Ring-Opening Polymerization of Racemic β-Butyrolactone with Discrete Yttrium Catalysts,” Macromolecules, v.42(4), pp. 987-993.
3. Carpentier, J. F. (2010) “Discrete Metal Catalysts for Stereoselective Ring-Opening Polymerization of Chiral Racemic β-Lactones,” Macrom. Rapid Commun., v.31(19), pp. 1696-1705.
4. Abe, H. et al. (1994) “Physical Properties and Enzymatic Degradability of Poly(3-hydroxybutyrate) Stereoisomers with Different Stereoregularities,” Macromolecules, v.27(21), pp. 6018-6025.
5. Ligny, R. et al. (2018) “Steric vs. electronic stereocontrol in syndio- or iso-selective ROP of functional chiral β-lactones mediated by achiral yttrium-bisphenolate complexes,” Chem. Commun., v.54(58), pp. 8024-8031.
6. Platel, R. et al. (2020) “Precise Microstructure Control in Poly(hydroxybutyrate-co-lactic Acid) Copolymers Prepared by an Yttrium Amine Bis(phenolate) Complex,” Macromolecules, v.53(24), pp. 10773-10784.
7. Ligny, R. et al. (2019) “Yttrium-Mediated Ring-Opening Copolymerization of Oppositely Configurated 4-Alkoxymethylene-β-Propiolactones: Effective Access to Highly Alternated Isotactic Functional PHAs,” Chem. Eur. J., v.25(25), pp. 6412-6424.
8. W02016/057083-Tepha “Medical Devices Containing Dry Spun Non-wovens of Poly-4-hydroxybutyrate and Copolymers with Anisotropic Properties”.
9. W02002/028968-Proctor-Gamble “Biodegradable Polyester Blend Compositions and Methods ofMaking the Same”.
10. W02002/028969-Proctor-Gamble “Plastic Products Comprising Biodegradable Polyester Blend Compositions”.
11. W01999-005207-Monsanto ‘PHA Compositions and Methods for their Use in the Production of PHA Films’.
12. Jost, V. (2018) “Packaging related properties of commercially available biopolymers—An Overview of the status quo,” Express Polymer Letters, v.12, pp. 429-435.
13. Zhang, H. et al. (2009) “Biosynthesis and Characterization of 3-Hydroxyalkanoate Terpolyesters With Adjustable Properties by Aeromonas hydrophila,” Biotechnology and Bioengineering, v.104(3), pp. 582-589.
14. Chia, K. et al. (2010) “Biosynthesis and characterization of novel polyhydroxyalkanoate polymers with high elastic property by Cupriavidus necator PHB-4 transformant,” Polymer Degradation and Stability, v.95(12), pp. 2226-2232.
15. U.S. Patent Publication 2009/0149555.

### SUMMARY

A method for preparing a polyhydroxyalkanoate polymer, comprising: performing ring-opening polymerization of at least two of the following lactone monomers, a first lactone monomer having Formula (I)

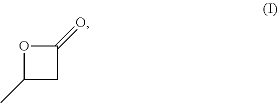

a second lactone monomer having Formula (II)

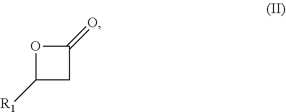

and a third lactone monomer having Formula (III)

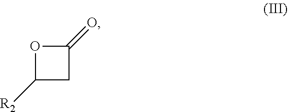

wherein at least one of the lactone monomers are racemates or enantiomerically enriched mixtures, respectively, and R₁ and R₂ are each independently CₙH₂ₙ₊₁, wherein n ranges from 2 to 6, preferably 2 to 4, and R₁ and R₂ are not the same.

### BRIEF DESCRIPTION OF THE FIGS.

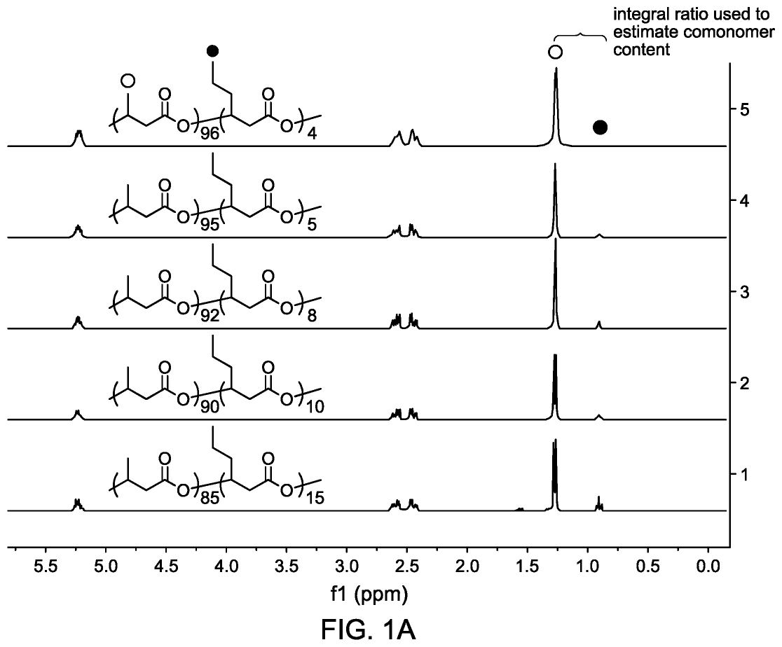

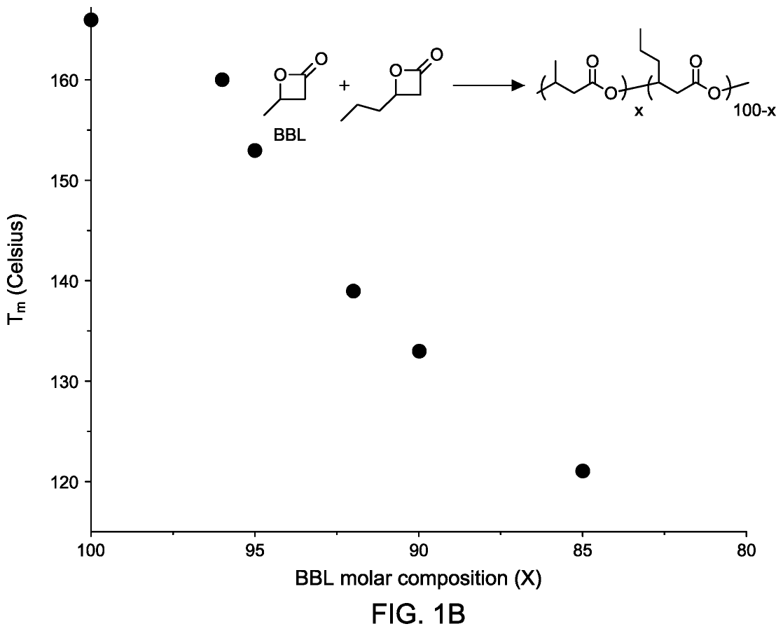

FIG. 1A is a representative ¹H NMR spectra of copolymers prepared from R=C₃H₇ and R₃=Ph.

FIG. 1B is a plot of Tₘ vs BBL molar composition (X).

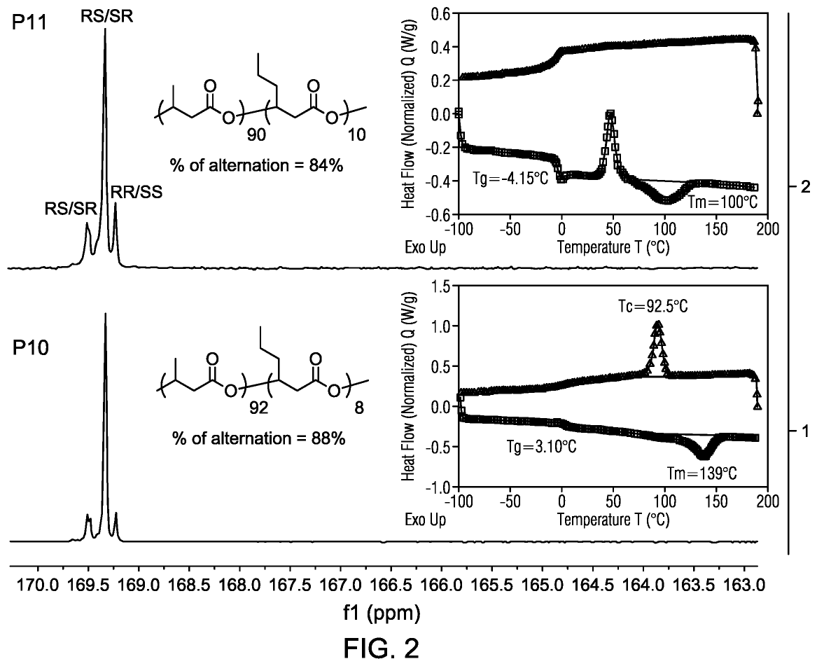

FIG. 2 is a representative 13C NMR spectra and DSC thermograms (insets) of copolymers prepared from R=C₃H₇, and either R₃=CH₃, top, or R₃=Ph, bottom.

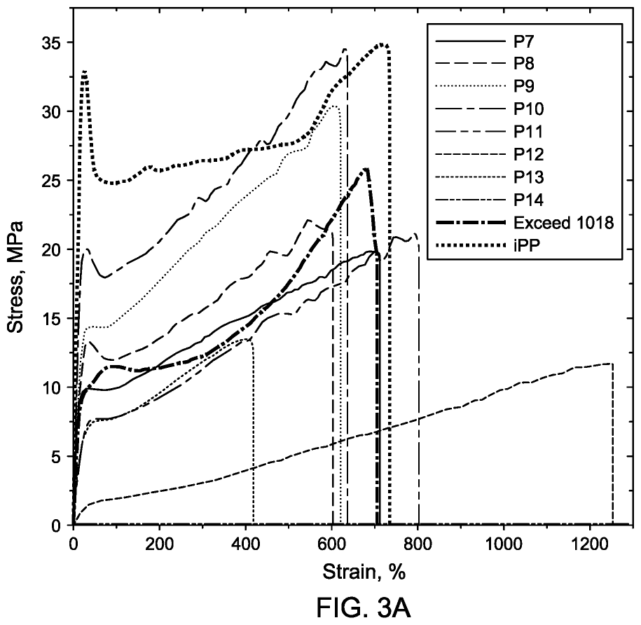

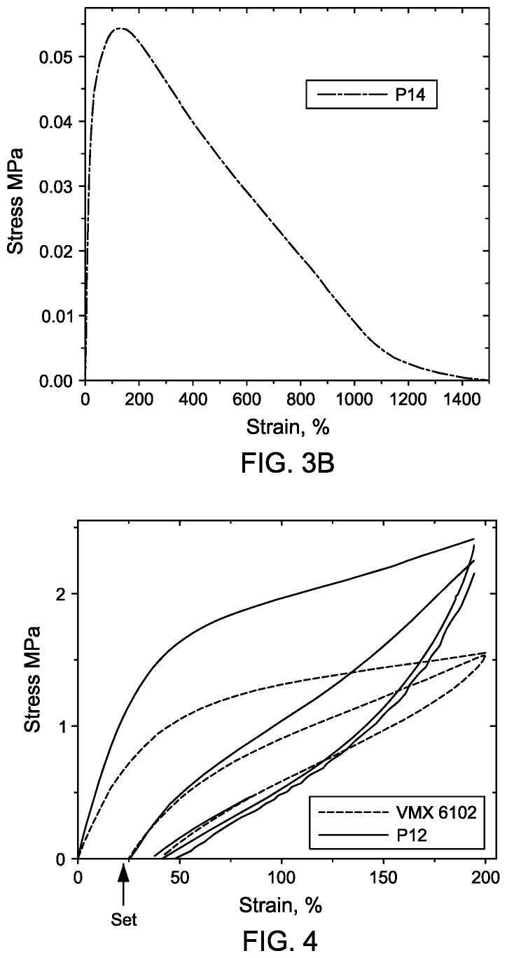

FIG. 3A are stress-strain curves for PHA copolymers measured at 25° C.

FIG. 3B is the tensile response of sample P14.

FIG. 4 Is a hysteresis of PHA copolymer P12 and a propylene elastomer, measured at 25° C.

### DETAILED DESCRIPTION

For the purposes of this invention and the claims thereto, the new numbering scheme for the Periodic Table Groups is used as described in Chemical and Engineering News, v.63(5), pg. 27 (1985). Therefore, a “group 4 metal” is an element from group 4 of the Periodic Table, e.g. Hf, Ti, or Zr, and a “group 3 metal” is an element from group 3 of the Periodic Table, e.g., scandium or yttrium. Ph is phenyl.

RT is room temperature and is 23° C. unless otherwise indicated.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are reported in units of g/mol (g mol⁻¹).

A “polymer” has two or more of the same or different mer units. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomerically. Thus, as used herein, polymer generically encompasses a copolymer and terpolymer.

The ring-opening polymerization (ROP) of racemic lactones is an alternative route to PHAs that can realize copolymers with tailored compositions and microstructure (e.g. stereo-regularity), a feature that is absent in the commercially-practiced biosynthetic route. Consequently, structure-property relationships can be established and serve as a guide to targeting materials with specified properties. The following is an exemplary description of the preparation of exemplary copolymers and their thermal and mechanical properties that can be tuned to match those of current commercially offered polyolefin-based products such as polypropylene, LLDPE, PP-based elastomers (branded as Vistamaxx®), and EP rubbers.

A typical experiment is carried out under an inert atmosphere at room temperature and ambient pressure. Yttrium precatalyst 4 (ca. 120 mg) and ligand 3 (ca. 144 mg) are dissolved in 46 mL of anhydrous toluene. After stirring for 5 minutes, the solution is added to a racemic comonomer mixture (1 and 2) and stirred between 24 and 72 hours. The copolymer is then precipitated by adding the viscous solution or gel to stirring methanol, isolated by vacuum filtration, and dried in a vacuum oven at 60° C. for 24 hours. Copolymer composition was determined by comparing the relative integral ratios of the CH₃ substituents on the aliphatic side groups (FIG. 1A) and found to correlate well with copolymer melt transition temperature Tₘ (FIG. 1B).

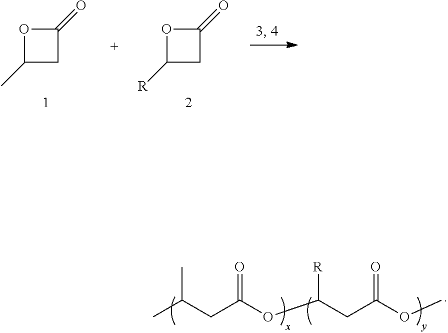

Monomers 1 and 2, shown above, are racemates or enatiomerically enriched mixtures. However, the enantiomeric ratios for monomer 1 and 2 are not necessarily equal to each other.

R can be any linear or branched aliphatic group, preferably CₙH₂ₙ₊₁, where n can range from 2 to 6, preferably 2 to 4 or 3 to 4. x+y=100. x and y are molar compositions and do not have to be whole numbers (i.e., they can be fractional such as 99.5), but preferably they are integer values equal to 1 to 99.

Copolymers in the above example are predominantly syndiotactic with a high degree of alternating R and S stereocenters.

In some embodiments, copolymers embodying the present technological advancement can have Mw greater than 100 Da, greater than 1000 Da, greater than 10,000 Da, or greater than 100,000 Da.

In this example, the ligand/metal combination (shown below) was used to generate the catalyst in situ by pre-dissolving molar equivalents of the bisphenol ligand (3) with the yttrium amido pre-catalyst (4). One can add a molar equivalent of an aliphatic linear or branched alcohol (such as isopropyl alcohol) to the mixture prior to polymerization initiation. Some diols, triols, and tetrols can also be used.

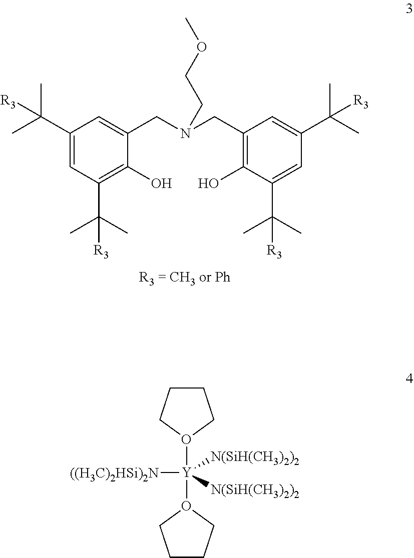

Alternatively, the following ligand A can be combined with 4 to produce species B and can add a molar equivalent of an aliphatic linear or branched alcohol (such as isopropyl alcohol) affording (C). Both species B and C catalyze ROP of lactones.

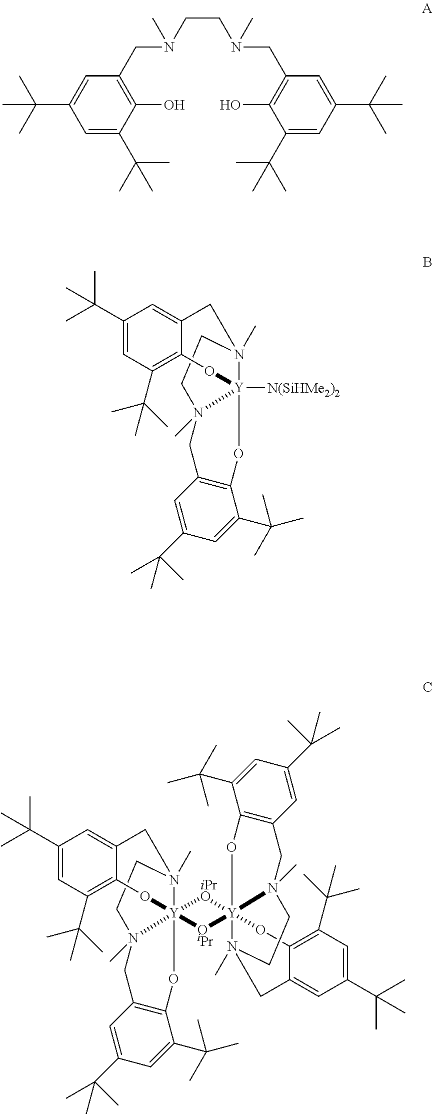

Preferably, the catalyst useable with the present technological advancement affords polymers that are predominantly syndiotactic with a high degree of alternating R and S stereocenters. Not to be bound by theory, but it is believed that the syndiotactic microstructure influences the polymer's semi-crystallinity, processability, and mechanical properties. Thus, syndiotactic polymers are preferred over isotactic or atactic polymers in some instances.

The present technological advancement is useable with catalysts not generated in situ. For example, the discrete catalysts 6 and 7 (shown below) can also be prepared and used to produce polymers described herein. In this scheme, R₄OH can be an aliphatic linear or branched alcohol, or it can be a diol, triol, or tetrol, wherein R₄ can be isopropyl alcohol.

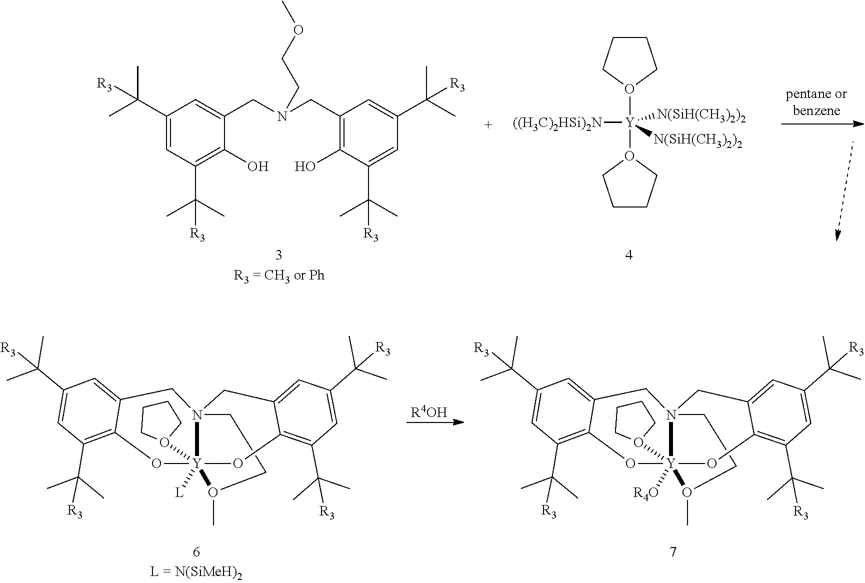

The above-noted metal precursor is not the only metal precursor useable with the present technological advancement. For example, the ligand and metal precursors in U.S. patent publication 2009/0149555 can be useable with the present technological advancement in some embodiments.

For example, (Y[N(SiHMe₂)₂]₃(THF)₂) could be used. More generally, the metal precursor can by YQ₃Sₙ, where Q is NR′₂, R″₃, or X₃, S is a Lewis base including solvent molecules such as nitrogen donors (amines, pyridine, nitrile groups, etc.), oxygen donors (ethers such as diethyl ether, methyl tert-butyl ether, tetrahydrofuran, trialkylphosphine oxides, etc.), phosphine donors (trialkyl phosphine such as tributylphosphine, triphenylphosphine, etc.), sulfur donors such as thiophene, dimethyl sulfide, etc., R′ is a hydrocarbyl group including Si groups, R″ is a hydrocarbyl group (including oxygen containing fragments) such as CH₂CMe₃, CH₂SiMe₃, CH₂C(CH₃)₂(C₆H₅), —CH₂Si(OCH₃)₃, n is 0 to 3, and X is F, Cl, Br, or I.

In some exemplary embodiments, THF can be replaced by diethyl ether.

The present technological advancement can also be used to create terpolymers.

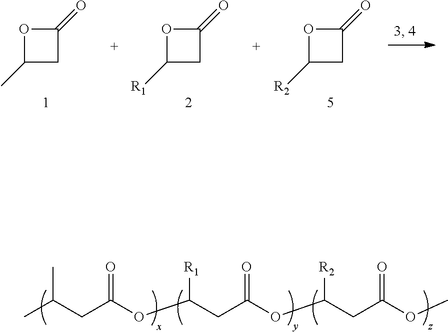

Monomers 1, 2, and 5 shown above, are racemates or enantiomerically enriched mixtures.

Terpolymers in the above example are predominantly syndiotactic with a high degree of alternating R and S stereocenters.

R₁ and R₂ can be any combination of linear or branched aliphatic group, R₁ not equal to R₂. Preferably R₁=C₃H₇ and R₂=C₄H₉. More generally, R₁ and R₂ can each independently be CₙH₂ₙ₊₁, with n ranging from 2 to 6, preferably 2 to 4 or 3 to 4, with R₁ not equal to R₂. x, y, and z are molar compositions and do not have to be whole numbers (i.e., they can be fractional such as 99.5), but preferably they are integer values equal to 1 to 99.

x+y+z=100.

In some embodiments, terpolymers embodying the present technological advancement can have Mw greater than 100 Da, greater than 1,000 Da, greater than 10,000 Da, or greater than 100,000 Da.

For the terpolymers, the same catalysts (in situ or otherwise) can be used as described above for the copolymers.

Furthermore, while the typical experimental setup described above may be a batch process, those of ordinary skill in the art will appreciate that such a process can be adapted to a continuous process.

Copolymer microstructure (e.g. stereo-regularity) can also be tailored to impart specific thermal and mechanical properties to the material by varying the catalyst structure and/or polymerization conditions. In the exemplary embodiments of the present technological advancement, two ligands (3; R₃=CH₃ or Ph) that impart different syndiospecificity to the catalyst during ROP were used to afford copolymers with comparable composition but different degrees of alternating R and S stereocenters along the polymer backbone, a metric defined as % of alternation (See “Polymerization of Enantiopure Monomers Using Syndiospecific Catalysts: A New Approach to Sequence Control in Polymer Synthesis”. Kramer, J. W.; Treitler, D. S.; Dunn, E. W.; Castro, P. M.; Roisnel, T.; Thomas, C. M.; Coates, G. W. J. Am. Chem. Soc. 2009, 131, 16042-16044). The metric can be estimated by comparing the relative integral ratios of the resonances assigned to the different diad sequences (i.e., RS/SR and RR/SS) in their ¹³C NMR spectra (FIG. 2). In sum, the copolymers have % of alternation values of 84% and 89% and Tₘ values of 100° C. and 139° C. respectively, showing conclusively that the thermal properties of copolymers with near identical composition can be tailored by tuning their microstructure. For example, the % of alternation values can range from 80% to 90%, 80% to 85%, 84% to 89%, or 85% to 90%.

H and ¹³C{¹H} NMR spectra were collected on a Bruker AVANCE spectrometer operating at 600 MHz and 151 MHz respectively (CDCl₃, 26° C.). The microstructures of the PHA copolymers were determined from the carbonyl region of the ¹³C{¹H} NMR spectra. NMR data acquisition was done with the Bruker pulse program Zgpg and the following parameters: D1=5_{S}, number of scans=10,000, and P1=10.8 μs. Collected: 65k points per FID.

While embodiments described herein have R₃=CH₃ or Ph, R₃ can be a C₁₋₁₅ alkyl group such as a methyl, ethyl. isopropyl, n-propyl, isobutyl or tert-butyl group, or a benzyl group.

Table 1 shows composition, glass transition temperature (Tg), crystallization temperature (Tc) and melting temperature (Tₘ) measured by DSC. Differential Scanning Calorimetry (“DSC”) measurements were performed using a DSC2500™ instrument (TA Instruments™) to determine the thermal transition points of the polymers. Heating and cooling temperature ramps were set within the temperature range of −100° C. to 190° C. with a heating/cooling rate of 10° C./min. The T_{g} values are determined as the temperatures at the inflexion point on the DSC thermograms and the melting and crystallization temperatures (Tₘ and T_{c}, respectively) as the peak temperatures in the heating and cooling ramps, respectively. Tₘ is measured during the second heating cycle.

A typical experiment is carried out under an inert atmosphere at room temperature and ambient pressure. Yttrium precatalyst 4 (ca. 120 mg) and ligand 3 (R₃=Ph, ca. 144 mg) are dissolved in 46 mL of anhydrous toluene. After stirring for 5 minutes, the solution is added to a racemic comonomer mixture (1 and 2) and stirred between 24 and 72 hours. The copolymer is then precipitated by adding the viscous solution or gel to stirring methanol, isolated by vacuum filtration, and dried in a vacuum oven at 60° C. for 24 hours. Copolymer composition was determined by comparing the relative integral ratios of the CH₃ substituents on the aliphatic side groups.

The copolymerization is carried out in a solvent chosen from toluene, methylcyclohexane, chlorobenzene and mixtures thereof, and the polymerization is carried out at a temperature from −30° C. to 120° C., preferably from 0° C. to 60° C., more preferably from 15° C. to 30° C., for example at 20° C. Any solvent that can dissolve the catalyst or catalyst components without compromising the catalyst's ability to polymerize the comonomers could be useable with the present technological advancement. β-butyrolactone is not miscible with methylcyclohexane, but it can still polymerize in it.

TABLE 1

| | | | | | | | Tₘ (DSC |
|---|---|---|---|---|---|---|---|
| | | BBL | | | | T_{c} (DSC | peak, 2^{nd} |
| Reference | Comonomer | mol | Mₙ | % of | T_{g}, | peak), | heat), |
| # | Type | % | (kDa) | Alternation | ° C. | ° C. | ° C. |
| P1 | 4-propyloxetan- | 96 | 56 | 90% | 5.62 | 116 | 160.2 |
| | 2-one | | | | | | |
| P2 | 4-propyloxetan- | 95 | 53 | 90% | 4.29 | 109.1 | 152.7 |
| | 2-one | | | | | | |
| P3 | 4-butyloxtan- | 97 | 42 | 88% | 4.6 | 111.1 | 159.6 |
| | 2-one | | | | | | |
| P4 | 4-butyloxtan- | 95 | 60 | 90% | 3.92 | 95.36 | 148.9 |
| | 2-one | | | | | | |
| P5 | 4-propyloxetan- | 0 | 59 | 87% | −19.8 | — | 74.4^{a} |
| | 2-one | | | | | | |
| P6 | 4-butyloxtan- | 0 | 46 | 91% | −29.1 | — | 61.0^{a} |
| | 2-one | | | | | | |
| P7 | 4-propyloxetan- | 85 | 28 | 88% | −2.38 | 49.5 | 121 |
| | 2-one | | | | | | |
| P8 | 4-butyloxtan- | 89 | 26 | 91% | 0.33 | 58.8 | 126 |
| | 2-one | | | | | | |
| P9 | 4-propyloxetan- | 90 | 43 | 88% | −1.64 | 77 | 133 |
| | 2-one | | | | | | |
| P10 | 4-propyloxetan- | 92 | 69 | 88% | 3.1 | 92.5 | 139 |
| | 2-one | | | | | | |
| P11^{c} | 4-propyloxetan- | 90 | 38 | 84% | −4.77 | — | 103 |
| | 2-one | | | | | | |
| P12 | 4-butyloxtan- | 68 | 62 | 91% | −11.9 | — | 65.3 |
| | 2-one | | | | | | |
| P13 | 4-propyloxetan- | 78 | 24 | 94% | −5.97 | — | 89.5 |
| | 2-one | | | | | | |
| P14 | 4-butyloxtan- | 51^{d} | 91 | 90%^{d} | −14.4 | — | —^{b} |
| | 2-one + 4- | | | | | | |
| | propyloxetan- | | | | | | |
| | 2-one | | | | | | |

[Comonomer]₀/[4] = ca. 600; [3]:[4] = ca. 1; toluene, 25° C. Bisphenol ligand 3 (R₃ = Ph).
^{a}First heat.
^{b}Amorphous.
^{c}Bisphenol ligand 3 (R₃ = CH₃).
^{d}Estimate was used for this reaction.

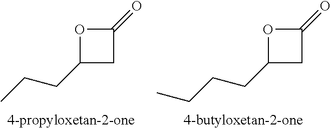

Any of the values in table 1 can provide the end points for ranges that define their respective measurement or property, with an additional +/−10%. Preferably, Tg can range from −30° C. to 10° C. and Tₘ can range from 50° C. to 170° C. The molecular weight moments (Mn, Mw, and Mz) of PHB homopolymer and copolymers were measured by Gel Permeation Chromatography (GPC) equipped with a multi-set of Agilent PLGel mixed-B columns and multiple detectors. The GPC system operates in chloroform solvent at 40° C. with a flow rate of 1 mL/min. The MW of PS standards for column calibration ranges from 300 to 12 M g/mol. The dn/dc and Mark-Houwink parameters (K, α) used for PHB molecular weight calculation are determined to be 0.034 mL/mg and 0.000286 dL/g, 0.699 respectively.

The present technological advancement is not limited to polymers of BBL, 4-propyloxetan-2-one, and/or 4-butyloxetan-2-one. Lactones usable with the present technological advancement include the following:

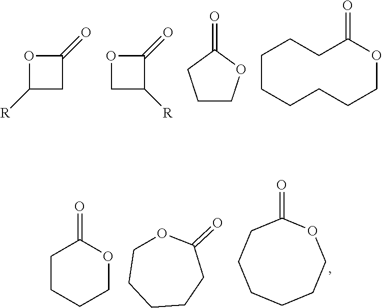

where R is CₙH₂ₙ₊₁, wherein n ranges from 2 to 6, preferably 2 to 4.

Moreover, the present technological advancement shows how to control the tensile properties of the copolymers using the methods listed above allowing for the design of copolymers with desired properties towards commercial applications. Particularly, one can tune the mechanical properties of these polymers via comonomer incorporation or tacticity.

The response to tensile deformation is shown in FIG. 3. Values of the tensile properties are given in Table 2. These data show that by changing the commoner content in the PHA copolymers, it is possible to obtain properties ranging from stiff plastics, with high crystallinity (e.g., sample P7), to rubbers, with zero crystallinity (sample P14). FIGS. 3A and 3b compares the PHA copolymers to an ethylene 1-hexene copolymer resin branded as Exceed™ 1018. Moreover, it is possible to tune the crystallinity to a value low enough to obtained elastomeric response. An example of this behavior is shown in FIG. 4, which shows tensile hysteresis data for sample P12 and for a propylene elastomer branded as Vistamaxx® 6102.

TABLE 2

| | Secant | Strain | Yield | | |
|---|---|---|---|---|---|
| Reference | Modulus, | at yield, | Stress, | Strain at | Ultimate Tensile |
| # | MPa | % | MPa | break, % | Strength, MPa |
| P7 | 59 | 40 | 10 | 600 | 18 |
| P8 | 70 | 37 | 13 | 550 | 22 |
| P9 | 82.2 | 37 | 14.5 | 610 | 30 |
| P10 | 155 | 31 | 20 | 600 | 34 |
| P11 | 37.6 | 55 | 7.83 | 800 | 21 |
| P12 | 4.8 | —^{a} | — | 1220 | 12.5 |
| P13 | 33.2 | 49.5 | 7.5 | 410 | 13.6 |
| P14 | 0.25 | —^{b} | —^{b} | —^{b} | —^{b} |

^{a}No yield. Elastomeric behavior.
^{b}Amorphous

Tensile testing were carried out in dumbbell-shaped specimens of thickness between 0.3 m to 0.5 mm, width between 1.5 mm and 2 mm and length of 3.5 mm. The dumbbell specimen were molded in a hot press at 170° C. After molding, the specimens were aged at room temperature for 24 hours before the tests. The tensile tests were carried out at 22° C. using a mechanical solid analyzer RSA-G2 (TA Instruments) using a linear deformation rate or 100 microns/s. The equipment records axial force measurements as a function of strain. The instantaneous engineering stress values are computed as the measured force divided by the initial cross section are of the specimens.

Sec Mod: modulus measured at 2% strain. Strain at yield and Yield stress: measured at the peak in the stress-strain curve. Strain at break: maximum strain reached before break. Ultimate tensile strength (max stress reached before break). Ranges for these values are defined by any combination of the values recited in Table 2, +/−10%.

Any of the values in Table 2 can provide the end points for ranges that define their respective measurement or property, with an additional +/−10%. Preferably, secant modulus can range from 0.1 to 500 MPa, tensile strength can range from 10 to 100 MPa, and strain break can range from 100 to 1500%.

In order to fully understand the effect of substitution pattern and the choice of solvent or temperature on the polymer properties, a ligand screening was conducted using a Group 3 metal precursor (Y[N(SiHMe₂)₂]₃(THF)₂) to be consistent with literature as it is one of the most common metal precursors for this type of chemistry. THF refers to tetrahydrofuran. Since both the ligands and the metal precursor were found to be soluble in the solvents of interest, it was decided to generate the catalyst in situ and combine with the lactone for polymerization.

In a typical polymerization reaction, the metal precursor dissolved in a suitable solvent was added to a solution of ligand at room temperature. The solution was then stirred for five minutes to allow the active species to form. The catalyst solution then was injected into a solution of the lactone and stirred. The polymers were isolated by precipitating into methanol, washing with methanol, and drying under vacuum. The tacticity (or lack of) was determined by ¹³C NMR spectroscopy as described in literature (see, i) Ebrahimi, Tannaz (2017) “Synthesis and Rheological Characterization of Polyhydroxybutyrate with Different Topologies and Microstructures,” University of British Columbia, the entirety contents of which are hereby incorporated by reference and ii) Kramer, J. et al. (2009) “Polymerization of Enantiopure Monomers Using Syndiospecific Catalysts: A New Approach to Sequence Control in Polymer Synthesis,” J. Am. Chem. Soc., v.131(44), 16042-16044.) and Tₘ values were measured by DSC.

Any of the foregoing polymers and compositions in combination with optional additives (anti-oxidants, colorants, dyes, stabilizers, filler, chain-extenders, plasticizers etc.) may be used in a variety of end-use applications produced by methods known in the art, including but not limited to mulch films, films for packaging, food packaging, biomedical devices, biomedical applications, surgical fasteners, sutures, agrafes, plates, or controlled release of medications.

All documents described herein are incorporated by reference herein, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including.” Likewise whenever a composition, an element or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges may appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

1. A method for preparing a polyhydroxyalkanoate polymer, comprising:
performing ring-opening polymerization of at least two of the following lactone monomers, a first lactone monomer having Formula (I) 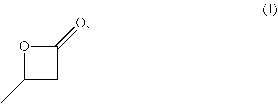
a second lactone monomer having Formula (II) 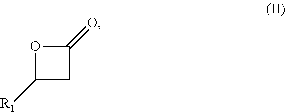
and a third lactone monomer having Formula (III) 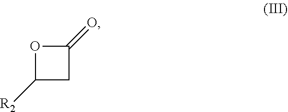
wherein at least one of the lactone monomers are racemates or enantiomerically enriched mixtures, respectively, and R₁ and R₂ are each independently CₙH₂ₙ₊₁, wherein n ranges from 2 to 6, and R₁ and R₂ are not the same.

2. The method of claim 1, further comprising recovering the polyhydroxyalkanoate polymer, wherein the polyhydroxyalkanoate polymer is syndiotactic and a degree of syndiotacticity is controlled by varying % of alternation of R and S stereocenters, or varying comonomer composition of the polymer.

3. The method of claim 1, wherein the polyhydroxyalkanoate polymer is either a copolymer with molar compositions x and y of the monomers being such that x+y=100 or a terpolymer with molar compositions x, y, and z of the monomers being such that x+y+z=100.

4. The method of claim 1, wherein the ring-opening polymerization includes the lactone monomers having more than 50 mol % of beta butyrolactone.

5. The method of claim 1, wherein the lactone monomers include two lactone monomers of beta butyrolactone and 4-propyloxetan-2-one.

6. The method of claim 1, wherein the lactone monomers include two lactone monomers of beta butyrolactone and 4-butyloxetan-2-one.

7. The method of claim 1, wherein the lactone monomers include three lactone monomers of beta butyrolactone, 4-propyloxetan-2-one, and 4-butyloxetan-2-one.

8. The method of claim 1, further comprising controlling Tₘ of the polyhydroxyalkanoate polymer by changing a degree of alternating R and S stereocenters along the copolymer backbone.

9. The method of claim 1, further comprising controlling Tₘ of the polyhydroxyalkanoate polymer by varying comonomer composition.

10. The method according to claim 1, in which the polymerization is carried out in a solvent selected from the group consisting of toluene, tetrahydrofuran, methylcyclohexane, chlorobenzene and mixtures thereof, and the polymerization is carried out at a temperature from −30° C. to 120° C.

11. The method of claim 1, wherein the ring-opening polymerization is carried out in a presence of a catalyst prepared in situ made from the following metal ligand combination, 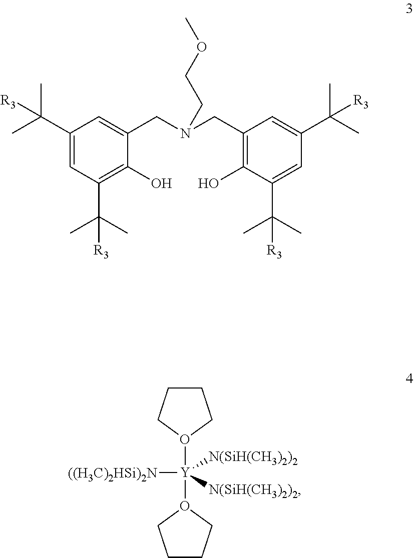
or
optionally a discrete catalyst derived from the metal ligand combination, and
wherein R₃ represents a C₁₋₁₅ alkyl group such as a methyl, ethyl, isopropyl, n-propyl, n-butyl, isobutyl or tert-butyl group, or a benzyl group.

12. The method of claim 11, wherein the discrete catalyst is used, and the discrete catalyst is one of the following: 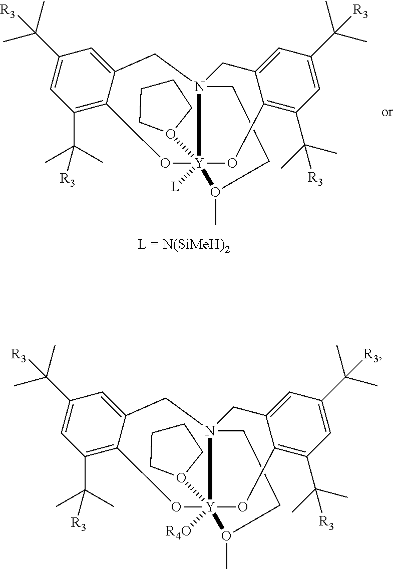
wherein R₄ is an aliphatic branched isopropyl alcohol.

13. The method of claim 1, wherein the ring-opening polymerization is carried out in a presence of at least one of the following catalysts: 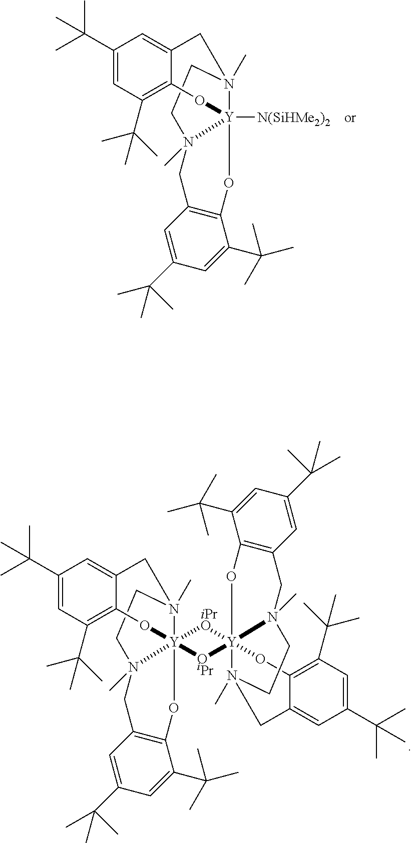
wherein the at least one catalyst is optionally prepared in situ.

14. A copolymer, having the following syndiotactic microstructure: 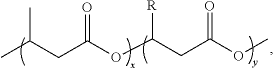
wherein x and y are molar compositions with such that x+y=100, and R is CₙH₂ₙ₊₁, with n ranging from 2 to 6.

15. The copolymer of claim 14, wherein thermal and mechanical properties of the copolymer are based on % of alternation determined by comparing relative integral ratios of resonances assigned to different diad sequences in their ¹³CNMR spectra.

16. The copolymer of claim 14, wherein % of alternation of the copolymer ranges from 80% to 90%.

17. The copolymer of claim 14, wherein the copolymer has Tg ranging from −30° C. to 10° C., Tₘ ranging from 50° C. to 170° C., a secant modulus ranging from 0.1 to 500 MPa, tensile strength ranging from 10 to 100 MPa, and strain break ranging from 100 to 1500%.

18. A terpolymer, having the following syndiotactic microstructure: 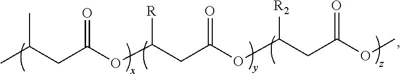
wherein x, y, and z are molar compositions with values such that x+y+z=100, and R₁ and R₂ are each independently CₙH₂ₙ₊₁, with R₁ not being equal to R₂, and n ranging from 2 to 6.

19. The terpolymer of claim 18, wherein thermal and mechanical properties of the terpolymer are based on % of alternation determined by comparing relative integral ratios of resonances assigned to different diad sequences in their ¹³CNMR spectra.

20. The terpolymer of claim 18, wherein % of alternation of the terpolymer ranges from 80% to 90%.

21. The terpolymer of claim 18, wherein the terpolymer has Tg ranging from −30° C. to 10° C., Tₘ ranging from 50° C. to 170° C., a secant modulus ranging from 0.1 to 500 MPa, tensile strength ranging from 10 to 100 MPa, and strain break ranging from 100 to 1500%.

22. A method for preparing a polyhydroxyalkanoate polymer, comprising:
performing ring-opening polymerization of at least two of the following lactone monomers, 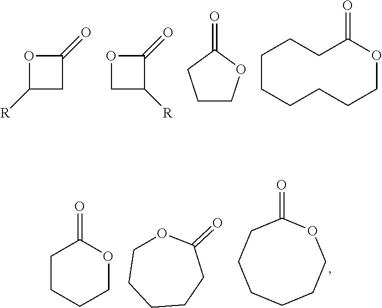
wherein R is CₙH₂ₙ₊₁, wherein n ranges from 2 to 6, and
wherein at least one of the at least two lactone monomers are racemates or enantiomerically enriched mixtures.
